(19) United States
(12) Patent Application Publication
(10) Pub. No.: US 2022/0253035 A1
(43) Pub. Date: Aug. 11, 2022

(54) SYSTEMS AND METHODS FOR MODELING NETWORK COMPONENTS IN PROVISIONING ENVIRONMENT

(71) Applicant: Verizon Patent and Licensing Inc., Basking Ridge, NJ (US)

(72) Inventors: Randolph Torres, Clermont, FL (US); Raman P. Jankiram, Chennai (IN); Dean Rader, Montclair, NJ (US); William J. Moran, Wesley Chapel, FL (US)

(21) Appl. No.: 17/168,851

(22) Filed: Feb. 5, 2021

(51) Int. Cl. G05B 19/408

(52) U.S. Cl. CPC G05B 19/408; G05B 2219/31055

(57) ABSTRACT

A system includes one or more devices. The devices are configured to: receive data input to a template for a network equipment part; convert the data into JavaScript Object Notation (JSON) name-value pairs; store the JSON name-value pairs in a database; receive a request to provision a network component for an access network; identify equipment parts that are to be used to assemble the network component; assemble the network component; and deploy the network component in the access network.

### BACKGROUND INFORMATION

To satisfy the needs and demands of users of mobile communication devices, providers of wireless communication services continue to improve and expand available services and networks used to deliver such services. One aspect of such improvements includes edge networks and options to utilize and implement such networks. Through the edge networks, a service provider may manage a large number of user devices that use different types of services and experience various conditions. Managing all various types of network connections under different conditions poses various challenges.

### BRIEF DESCRIPTION OF THE DRAWINGS

FIG. 1 depicts concepts described herein;

FIG. 2 illustrates an exemplary network environment in which the systems and methods of FIG. 1 may be implemented;

FIG. 3 depicts exemplary components of an exemplary network device of the networks of FIG. 2;

FIG. 4 shows exemplary logical components of the provisioning system of FIG. 1 according to one implementation;

FIG. 5 illustrates exemplary logical components of the template system of FIG. 4 according to one implementation;

FIG. 6 is a flow diagram of an exemplary process that is associated with the components of FIGS. 4 and 5, according to one implementation;

FIG. 7A depicts an exemplary model, of network components, in the template system of FIGS. 4 and 5 according to one implementation;

FIG. 7B depicts an exemplary user interface that displays equipment part data according to one implementation;

FIG. 8 shows exemplary JsavaScript Object Notation (JSON) name-value pairs that define an exemplary model component according to one implementation;

FIG. 9A shows a portion of an exemplary user interface that lists exemplary network components whose properties are stored in the databases of FIG. 5, according to one implementation;

FIG. 9B shows exemplary corresponding JSON name-value pairs for one of the components listed in the user interface of FIG. 9A, according to one implementation;

FIGS. 10A and 10B illustrate an exemplary user interface that displays a list of one or more network components and subcomponents and properties of the components and the subcomponents, according to one implementation; and

FIG. 11 shows an exemplary user interface that displays a list of ports and logical ports.

### DETAILED DESCRIPTION OF PREFERRED EMBODIMENTS

The following detailed description refers to the accompanying drawings. The same reference numbers in different drawings may identify the same or similar elements.

Advanced networks, such as Fifth Generation (5G) networks, not only can provide efficient and low latency communication services, but also have the flexibility to adapt to different service demands, usage patterns, and loads in particular geographical regions. An underlying network infrastructure can amplify such flexibility when the infrastructure has the ability to rapidly allocate hardware and software resources, such as Central Processing Unit (CPU) cycles, memories, network cards, antennas, virtual network functions, virtual machines, and other components at network edges, to support a particular set of communication services. By streamlining processes for equipment acquisition, assembly, activation, and deployment and processes for ingesting data pertaining to such equipment, the provisioning system can reduce the time for adapting the edge networks to meet user demands.

Systems and methods are described herein that allow for the automatic provisioning of components of, for example, heterogeneous networks. As an example, systems and methods are described that allow for importing component data, integrating the component data into various databases, and using the imported data to provision a heterogeneous mix of network components. The provisioning may include requesting the system to provision a network component. When the system receives a request to provision a network component, the system may allocate the equipment parts for designing, assembling, deploying, and activating the network component.

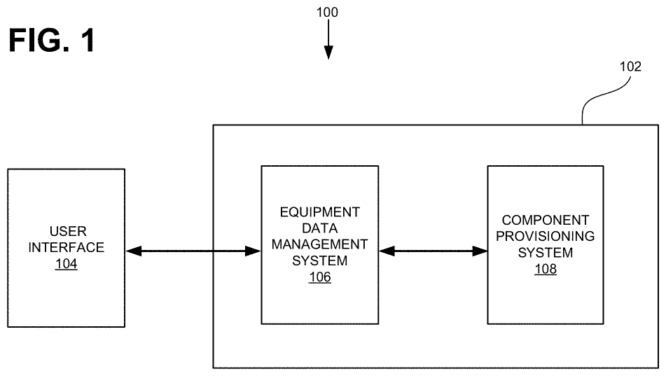

FIG. 1 depicts an example environment 100 that illustrates some of the concepts described herein. As shown, a provisioning system 102 includes equipment data management system 106 and component provisioning system 108. Through a user interface 104 (UI), a user (e.g., a vendor, a network operator, etc.) may input equipment data to equipment data management system 106. In one implementation, user interface 104 presents a template to the user, and as the data is input, a template data sheet is filled in at the equipment data management system 106. After the entry is complete, the equipment data management system 106 transforms the data into a model template. The model is conveyed as JavaScript Object Notation (JSON) formatted data into its database. Once the data is input, component provisioning system 108 uses the information to design a network component which may have been requested for provisioning by the system or a user (e.g., a network operator). Based on the data, the component provisioning system 108 assembles the component using the equipment parts, activates the component, and deploys the component in the network environment.

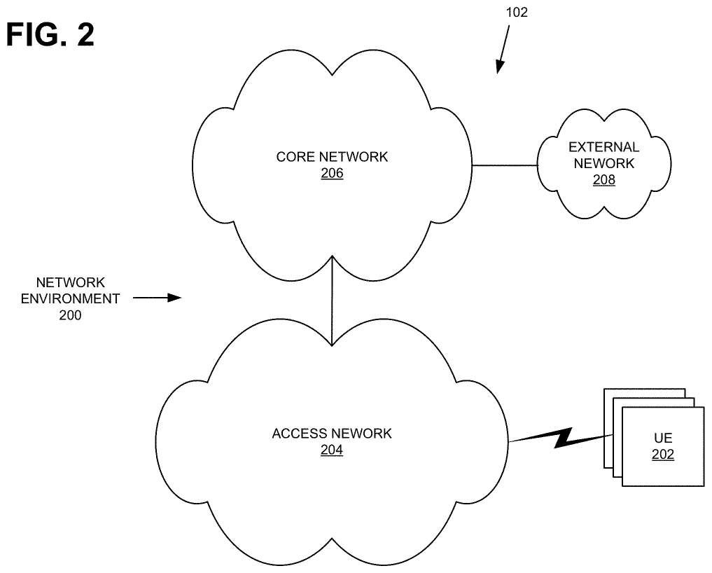

FIG. 2 illustrates an exemplary network environment 200 in which provisioning system 102 and methods associated with system 102 may be implemented. Network environment 200 may include one or more of UE devices (UEs) 202 (individually referred to as UE 202 or collectively referred to as UEs 202), an access network 204, a core network 206, and an external network 208.

UE 202 may include a wireless communication device. Examples of UEs 202 include: a smart phone; a tablet device; a wearable computer device (e.g., a smart watch); a laptop computer; a portable gaming system; and an Internet-of-Things (IoT) device. In some implementations, UE 202 may correspond to a wireless Machine-Type-Communication (MTC) device that communicates with other devices over a machine-to-machine (M2M) interface, such as Long-Term-Evolution for Machines (LTE-M) or Category M1 (CAT-M1) devices and Narrow Band (NB)-IoT devices. UEs 202 may send packets over or to access network 204.

Access network 204 may allow UEs 202 to access core network 206 and/or external network 208. To do so, access network 204 may establish and maintain, with participation from UE 202, an over-the-air channel with UE 202; and maintain backhaul channels with core network 206. Access network 204 may convey information through these channels, from UE 202 to core network 206 and vice versa.

Access network 204 may include a Fourth Generation (4G) radio network, a Fifth Generation (5G) radio network and/or another advanced radio network. These radio networks may include many wireless stations for establishing and maintaining an over-the-air channel with UE 202. The wireless station may include a 5G, 4G, or another type of wireless station (e.g., evolved Node B (eNB), next generation Node B (gNB), etc.) that includes one or more Radio Frequency (RF) transceivers. Depending on the implementation, the wireless stations may be coupled to Multi-Access Edge Computing (MEC) clusters in access network 204. The MEC clusters may be located geographically close to the wireless stations, and therefore also be close to UEs 202 serviced by access network 204 via the wireless stations. Due to its proximity to UEs 202, the MEC clusters may be capable of providing services to UEs 202 with minimal latency. Depending on the implementations, the MEC clusters may provide many core functions and/or other services, but at network edges.

Core network 206 may include a local area network (LAN), a wide area network (WAN), a metropolitan area network (MAN), an optical network, a cable television network, a satellite network, a wireless network (e.g., a Code Division Multiple Access (CDMA) network, a general packet radio service (GPRS) network, an LTE network (e.g., a 4G network), a 5G network, an ad hoc network, a telephone network (e.g., the Public Switched Telephone Network (PSTN)), an intranet, or a combination of networks. In some implementations, the advanced networks within core network 206, such as 5G network, and the other networks (if additional networks are included in core network 206) may be arranged to support network slicing.

Core network 206 may allow the delivery of communication services (e.g., Internet Protocol (IP) services) to UEs 202, and may interface with other networks, such as external network 208. Depending on the implementation, core network 206 may include 4G core network components (e.g., a Serving Gateway (SGW), a Packet data network Gateway (PGW), a Mobility Management Entity (MME), etc.), 5G core network components (e.g., Access and Mobility Function (AMF), Session Management Function (SMF), etc.) or another type of core network component. Core network 206 may also include other networks, such as an IP Multimedia Subsystem (IMS) network that may provide a Short Messaging Service (SMS), Voice-over-IP (VoIP) service, etc.

External network 208 may include networks that are external to core network 206. In some implementations, external network 208 may include packet data networks, such as an IP network.

Within the implementation shown in FIG. 2, system 102 may deploy components for core network 206 and access network 208. To support various deployments, system 102 may receive equipment data input from users (e.g., vendor agents or other types of users), transform the data into a template model, and send the model data to its database as JSON name-value pairs. Once the data is in its databases, system 102 may use the data to design and assemble network components and activate the network components for use.

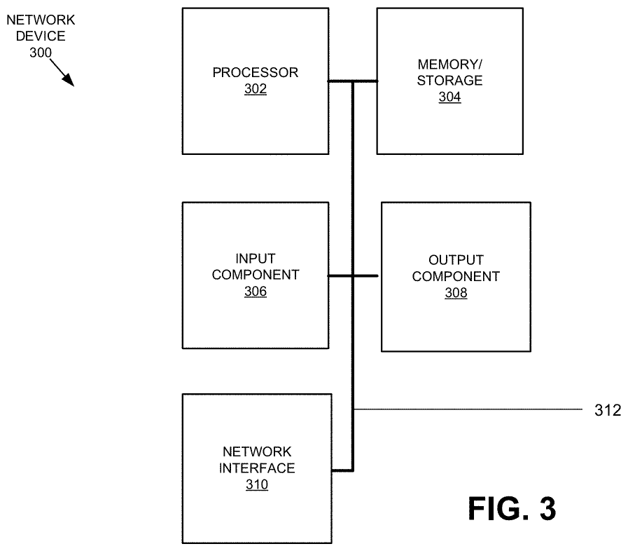

FIG. 3 depicts exemplary components of an exemplary network device 300. One or more of network device 300 correspond to, are included in, or provide hardware platforms for implementation of any of the network components of FIGS. 1 and 2 (e.g., equipment data management system 106, component provisioning system 108, a router, a network switch, servers, gateways, wireless stations, UEs 202, etc.). As shown, network device 300 includes a processor 302, memory/storage 304, input component 306, output component 308, network interface 310, and communication path 312. In different implementations, network device 300 may include additional, fewer, different, or a different arrangement of components than the ones illustrated in FIG. 3. For example, network device 300 may include a display, network card, etc.

Processor 302 may include a processor, a microprocessor, an Application Specific Integrated Circuit (ASIC), a Field Programmable Gate Array (FPGA), a programmable logic device, a chipset, an application specific instruction-set processor (ASIP), a system-on-chip (SoC), a central processing unit (CPU) (e.g., one or multiple cores), a microcontroller, and/or another processing logic device (e.g., embedded device) capable of controlling device 300 and/or executing programs/instructions.

Memory/storage 304 may include static memory, such as read only memory (ROM), and/or dynamic memory, such as random-access memory (RAM), or onboard cache, for storing data and machine-readable instructions (e.g., programs, scripts, etc.).

Memory/storage 304 may also include a floppy disk, CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 304 may be external to and/or removable from network device 300. Memory/storage 304 may include, for example, a Universal Serial Bus (USB) memory stick, a dongle, a hard disk, off-line storage, a Blu-Ray® disk (BD), etc. Memory/storage 304 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 306 and output component 308 may provide input and output from/to a user to/from network device 300. Input and output components 306 and 308 may include, for example, a display screen, a keyboard, a mouse, a speaker, actuators, sensors, gyroscope, accelerometer, a microphone, a camera, a DVD reader, Universal Serial Bus (USB) lines, and/or other types of components for obtaining, from physical events or phenomena, to and/or from signals that pertain to device 300.

Network interface 310 may include a transceiver (e.g., a transmitter and a receiver) for network device 300 to communicate with other devices and/or systems. For example, via network interface 310, network device 300 may communicate with wireless stations. Network interface 310 may also include an Ethernet interface to a LAN, and/or an interface/connection for connecting device 300 to other devices (e.g., a Bluetooth interface). For example, network interface 310 may include a wireless modem for modulation and demodulation.

Communication path 312 may enable components of network device 300 to communicate with one another.

Network device 300 may perform the operations described herein in response to processor 302 executing software instructions stored in a non-transient computer-readable medium, such as memory/storage 304. The software instructions may be read into memory/storage 304 from another computer-readable medium or from another device via network interface 310. The software instructions stored in memory or storage (e.g., memory/storage 304, when executed by processor 302, may cause processor 302 to perform processes that are described herein.

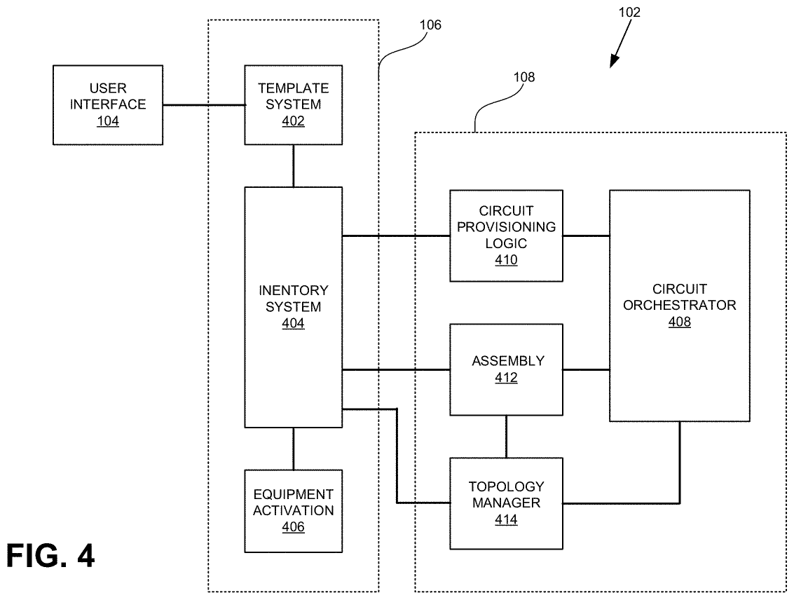

FIG. 4 shows exemplary logical components of the provisioning system 102 of FIG. 1. Provisioning system 102 may be implemented on one or more network devices 300, using a combination of hardware and software (e.g., application server, operating system, web server, etc.). As shown, equipment data management system 106 may include a template system 402, an inventory system 406, and an equipment activation system 406. Component provisioning system 108 may include a circuit orchestrator 408, circuit provisioning logic 410, assembly logic 412, and a topology manager 414. Depending on the implementation, each of equipment data management logic 106 and equipment provisioning logic 108 may include additional, fewer, and/or different components than those illustrated in FIG. 4.

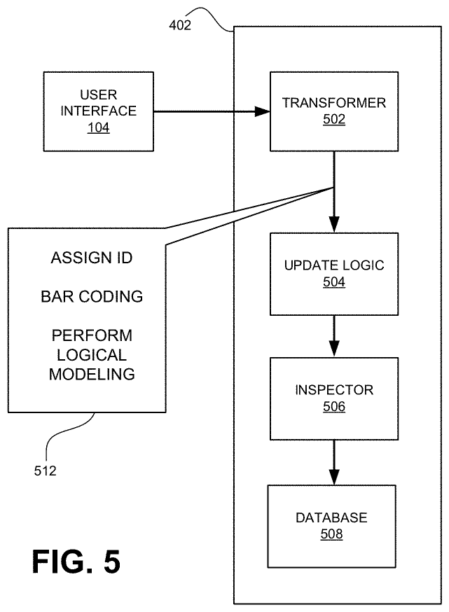

Template system 402 may allow users (e.g., vendor agents and/or network operators) to design new templates for a network component. In addition, template system 402 may provide reference data about what is possible to be deployed in the network and what is in the inventory. For a given template, various fields maybe mapped to JSON name-value pairs as explained below. After the design, a template for a particular component may be loaded into user interface 104, where a user may fill out the template. Upon receipt of the data from user interface 104, template system 402 may further process the data, as explained further below with reference to FIG. 5. After the processing, template system 402 may forward its equipment data to inventory system 404.

Inventory system 404 may track its inventory of equipment. Upon receipt of equipment data from template system 402, inventory system 404 may create instances of equipment from the reference data that depicts what is or what will be deployed in the network. In addition, inventory system 404 may indicate, in its database, equipment available for assembling network components and deployment. When the number of available equipment parts change due to their deployment (as part of the network component assembled), inventory system 404 records such status changes to the equipment in its database.

Equipment activation system 406 may activate a particular component (assembled from equipment parts), activate the component, and communicate with inventory system 404. In particular, when a component is activated, equipment activation system 406 may inform inventory system 404 identities of equipment parts that comprise the components are in use, and therefore not available for use in other components. If a network component is deactivated and disassembled, its equipment parts may be returned to the pool of equipment parts, available to be used to assemble other network components.

Circuit orchestrator 408 may receive requests for new network components for deployment from a user (e.g., a network operator) or from another system (e.g., a software component). After the receipt of a request, circuit orchestrator 408 may coordinate several of the subsystems of component provisioning system 108 to design, assemble, and activate the network component. For example, circuit orchestrator 408 may request circuit provisioning logic 410 to initiate the provisioning process.

Circuit provisioning logic 410 may receive instructions from circuit orchestrator 408, and identify equipment parts needed to assemble the component, based on, for example, input and output constraints (e.g., bandwidth, noise, etc.). Furthermore, provisioning logic 410 may determine whether the determined parts (or items that can be used as the determined parts) are available in the inventory, by consulting inventory system 404. Provisioning logic 410 may select specific available equipment parts, based on performance constraints provided by orchestrator 408. Provisioning logic 410 may have the ability to rank different types of available parts based on their capabilities, ratings, price, etc. Provisioning logic 410 may return IDs (e.g., part IDs) for the parts and the desired equipment configurations to orchestrator 408, which may then invoke assembly logic 412 in response.

Assembly logic 412 may select identified parts for assembly, activation, and deployment. Depending on the implementation, assembly logic 412 may have the ability to interconnect one piece of equipment part to another and/or to move the equipment parts. Assembly logic 412 may provide configuration settings of the selected equipment parts to topology manger 414, so that topology manager 414 can make any changes to its records of the network topology.

Topology manager 414 may receive instructions from orchestrator 408 and equipment configuration information from assembly logic 412, to update the network topology (i.e., which network components/parts are connected to which). Topology manger 414 may send equipment status information to inventory system 404, so that inventory system 404 may record their part status. Such equipment parts would no longer be in the inventory of available equipment parts. Inventory system 404 may still track the status of the deployed equipment, however. Thereafter, the assembled components may be activated by equipment activation system 406.

FIG. 5 illustrates exemplary logical components of the template system 402 of FIG. 4. Template system 402 may be implemented on one or more network devices 300, using a combination of hardware and software (e.g., application server, operating system, web server, etc.). As shown, template system 402 may include a transformer 502, update logic 504, inspector 506, and a database 508. Depending on the implementation, template system 402 may include additional, fewer, and different components than those illustrated in FIG. 5.

Transformer 502 may receive input for designing a template (e.g., fields) and modeling equipment part type. The input may designate various fields and their names. In addition, for the modeling, the input may include information that maps fields of the template to JSON name-value pairs. The mapping may include information that indicates child-parent relationship between different equipment types. For example, if input data pertains to an equipment part type that is a child to another equipment part type (e.g., the child equipment part plugs into the parent equipment part), the mapping information may indicate, for the child equipment part type, the parent (e.g., a pointer to the equipment part type data for the parent). The information may later be used after instance data for an equipment part is input by a user, to automatically retrieve and incorporate its parent/child component data (e.g., the name of the parent component, a pointer to the parent component data, etc.), as part of the instance data.

According to one implementation, the mapping information may comprise a piece of code or a script (e.g., JavaScript), that when executed, converts equipment data input into the template into JSON name-value pairs. Transformer 502 may store both the template and the mapping information in its database.

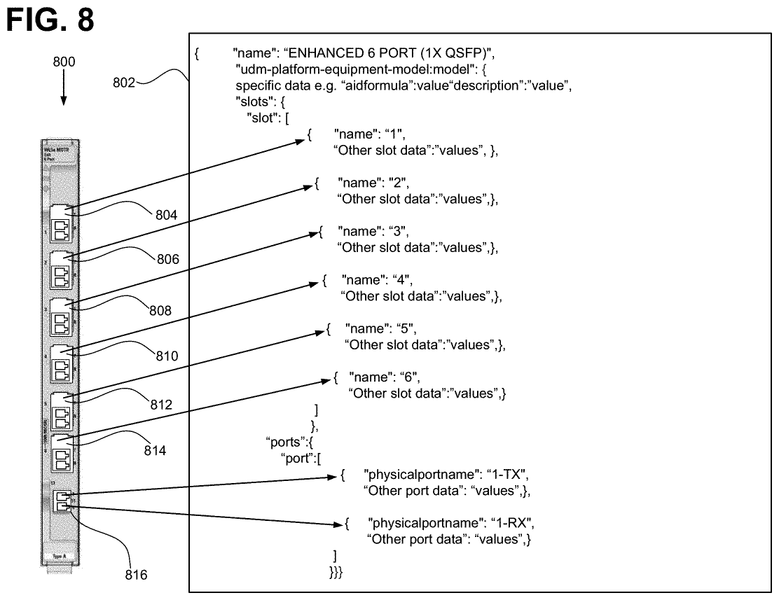

In addition, transformer 502 may also convert user input received through a template (selected from a list of templates for different equipment parts) from user interface 104. In one implementation, the data input by a user may be sent as form data associated with a particular template. After the data is received from user interface 104, transformer 502 may map the received data to JSON name-pairs, using the mapping information provided at the time of template design. An example of JSON name-value pairs for a network card is described below with reference to FIG. 8. After converting the data, transformer 502 may perform other tasks, such as bar coding, assignment of a part ID, logical modeling (e.g., logical modeling to map the nomenclature of the device software to the nomenclature of the inventory), and automated network card to a slot mapping, to incorporate such data to its equipment database 510.

Update logic 504 may update or create an entry pertaining to the equipment part. After the update, update logic 504 may forward the updated data to an inspector 506.

Inspector 506 may include mechanisms associated with inspecting the data from update logic 504. In one implementation, inspector 506 may comprise a GUI-based component that requests a user to inspect the data, make any necessary corrections, and approve the corrected data. In a different implementation, inspector 506 may include a machine-learning (ML) component (e.g., an Artificial Intelligence (AI) component, a neural network, etc.) trained to detect or modify the data so that it can be onboarded. In a different implementation, inspector 506 may include a module for detecting data errors and for warning human operators to correct the data. After the inspection and/or correction, the data is then uploaded into database 508.

Databases 508 may include equipment data (i.e., the corrected data output from inspector 506). The equipment data in database 508 may include, for each equipment part, information that provides a characterization of the part (e.g., physical dimensions, description, its relationship to another component, etc.). Once the data is stored in database 508, the data may be used to populate, for example, other databases, such as a database in inventory system 404. Such data may not only provide a list of equipment data, but their use status as well.

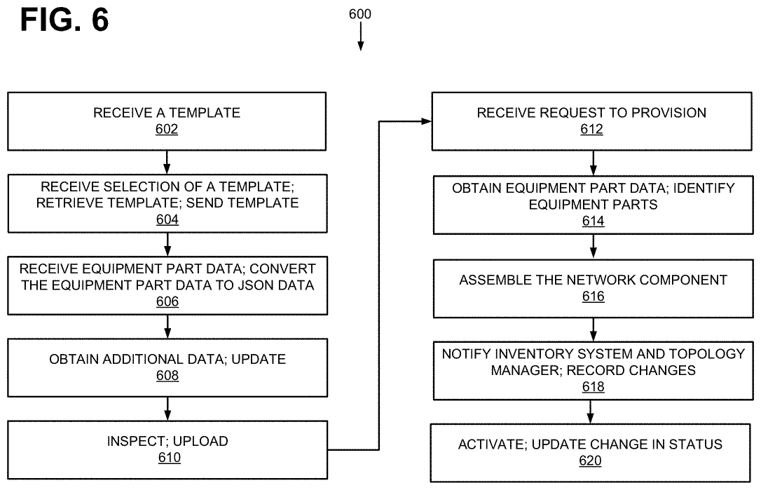

FIG. 6 is a flow diagram of an exemplary process 600 that is associated with the components of FIGS. 4 and 5. Process 600 may be performed by network device 300 executing computer-executable instructions loaded from memory. As shown, process 600 may include receiving a template (block 602) that includes various fields associated with an equipment part, from a user interface. The template may have been designed by the user, and may include fields names of the fields, and information that maps the fields to JSON name-value pairs. The map may also establish any relationship between the fields and other existing equipment data models for other equipment parts. Once received, the template may be stored in a database (e.g., a database within transformer 502 or another database (not shown in FIG. 5).

Process 600 may further include receiving a user's selection of a particular template for an equipment part (block 604), retrieving the template from its database in response to the selection, and sending the template to user interface 104. The user (e.g., a vendor agent) at the user interface 104 may then provide input data for the equipment part into the template.

After the user provides input (i.e., equipment part data) to the template at user interface 104, interface 104 may send the input data to template system 402. Template system 402 may receive the input (block 606). In one implementation, template system 402 may receive the data as Hypertext Markup Language (HTML) data associated with a template/form. After the receipt of the input, template system 402 may retrieve the mapping information associated with the template from its database and convert the input data into JSON name-value pairs using the mapping information. In one implementation, the mapping information may include a script, a piece of code, or a program. In such implementations, template system 402 may execute the script, the piece of code or the program to convert the data into JSON name-value pairs. In a different implementation, the mapping information may include a conversion table of symbols/strings. In the latter implementations, template system 402 may perform the conversion through table lookups.

Process 600 may further include obtaining additional data about the equipment part (block 608). In obtaining the additional data, sub-processes such as bar coding, assigning a part ID, establishing relationships between other equipment data based on modeling, etc., may be performed. Furthermore, the additional data may be combined with the converted data (i.e., use the additional data to update the converted data) (block 608).

After the data has been updated, the updated data may be inspected (block 610). The inspection, as described above, may be performed by presenting the updated data to a user, and having the user provide appropriate feedback (e.g., fix incorrect portion of data, input additional data, etc.). In a different implementation, an AI component (e.g., artificial neural networks, ML components, etc.) may perform the correction. In such implementations, the historical data-correction data may be used to further train the AI component. Thereafter, the inspected data may be uploaded to various databases, such as a database in inventory system 404 (610). Once the data has been uploaded, the data may be used for provisioning network components.

Process 600 may further include receiving a request to provision a network component from a user (e.g., a network operator) (block 612). For example, a network operator may request a circuit orchestrator 408 to provision a network component in an access network 204, to handle additional UEs 202 that may wirelessly attach to access network 204 without suffering any loss in service quality. When requested to provision a network component, orchestrator 408 may coordinate many of its subsystems to provision the network component, such as circuit provisioning logic 410. In the request for provisioning, the user may not only specify the type of network component and/or the environment in which the component is to be deployed, but also circuit performance constraints and requirements. For example, for a CPU or the memory, or a network card, the request may specify the number of cores, its computational speed, the amount of memory, the bandwidth, the number of physical ports, as well as other configurable parameters.

Process 600 may further include obtaining equipment part data from the inventory system 404 (block 614). Furthermore, using the data, provisioning logic 410 may identify the equipment parts that are to be used in assembling the network component (block 614). In one implementation, to identify the equipment parts, logic 410 may first obtain the inventory of all available equipment parts that can be used to assemble the network component from the inventory system 404. In situations where equipment parts that can be used to assemble the network component do not satisfy performance requirements, they are eliminated as potential equipment parts to be used to assemble the component. If there are multiple available equipment parts that are interchangeable, provisioning logic 410 may perform various design optimizations, such as, for example, deciding between two different types of available parts, by evaluating their performance characteristics, purchase prices, etc. After identifying all of the equipment parts are to be used to assemble the component, the provisioning logic 410 may forward a list of the identified equipment parts to orchestrator 408 or assembly logic 412.

Process 600 may further include assembling the network component based on the list of equipment parts provided by the provisioning logic 410 (block 616). For example, circuit orchestrator 408 may instruct assembly logic 412 to assemble the network component. In some implementations, assembling the network component may include physically moving the equipment parts, interconnecting them (e.g., plugging one component to anther), and/or physically arranging them. After the assembly, assembly logic 412 may notify the inventory system 404 and the topology manager 414 about the assembly (block 618). In response, the inventory system 404 and topology manager 414 may record the changes (block 618). For example, inventory system 404 may record the status of the equipment parts, indicating that they are now part of a network component, ready to be deployed, and/or that they are no longer available to be used as part of another network component. Topology manager 414 may record modifications in the network topology due to connecting/integrating the newly assembled network component into the network. Once the recording activities at the inventory system 404 and topology manager 414 have been performed, the network component/the equipment parts may be activated (block 620). Any change in the status of the equipment parts (e.g., active status) may be indicated in the inventory manager 404's database (block 620).

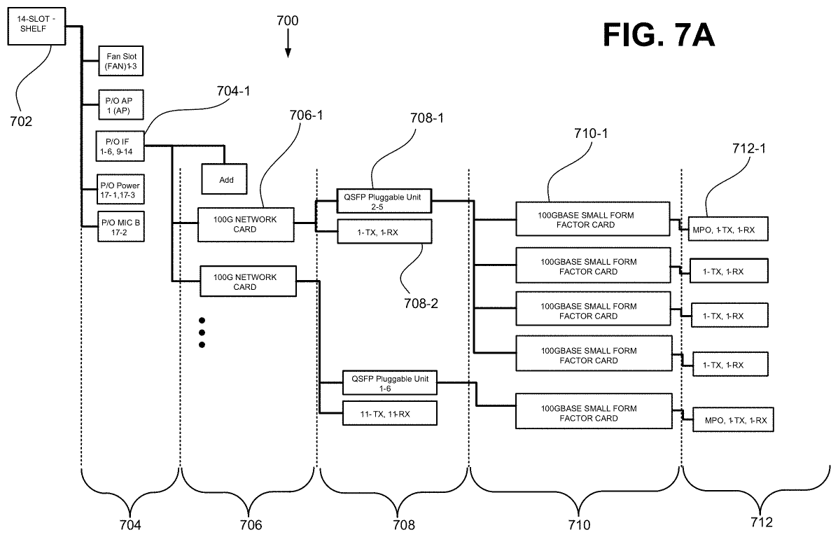

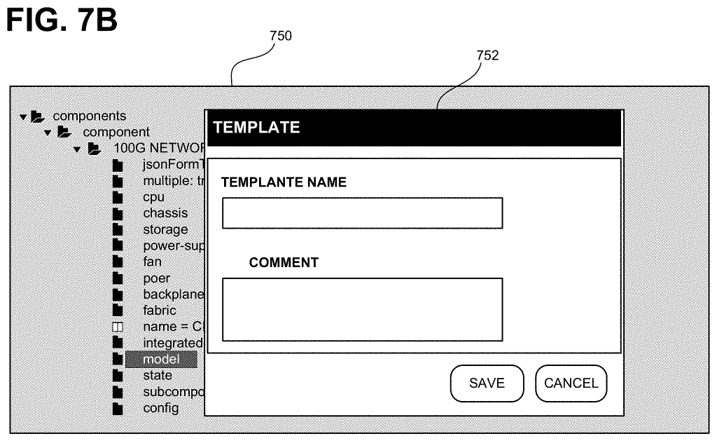

FIG. 7A depicts an exemplary model 700, of network components, in the template system 402 of FIG. 4 according to one implementation. As explained further below, information that corresponds to model 700 may be stored in template system 402. The stored information may be used, for example, to retrieve templates to display at user interface 104. As shown, the model is of a shelf 702 that includes slots 704. Shelf 702, as depicted, is a reference model, and therefore it illustrates the type of constituent models that the model includes, and the hierarchical relationship between the model and the constituent models. In contrast to the reference model, an instance model reflects physical equipment parts. That is, the model would reflect the state of physical equipment parts in inventory.

Shelf 702 may include multiple child slots 704, into which a particular type of card may be inserted. For example, different types of cards 706 can be plugged into slot 704-1. Since model 702 is a reference model, cards 706 correspond to network card types, and not to physical equipment parts. In FIG. 7A, a card type 706-1 is shown as including 100G NETWORK CARD. Each card type in cards 706 may host pluggable components 708 (e.g., network cards) and/or ports (e.g., 708-2).

Each Pluggable components 708 may include network cards. For example, pluggable component 708-1 may include multiple cards 710. Each of cards 710 (e.g., card 710-1) includes a particular card model, having multiple ports 712. For example, card 710-1 includes 100 GBASE SMALL FORM FACTOR CARD, with a physical port 712-1.

In one implementation, each of the components 702-712 is related to others via pointers, as child-parent. For example, each of slots 704 points to child cards 706, rather than including full copies of the data that represent the children cards. Accordingly, given slot 704-1, it is possible to use its pointer to locate its subcomponents 706. In a different implementation, model 700 may be created without using pointers, such that each of components 704-712 is part of a larger contiguous data set.

As noted above, model 700 may be stored and used by system 402, for retrieving or creating templates that user interface 104 displays to the user. FIG. 7B depicts an exemplary user interface 750 that displays equipment part data according to one implementation. The data that interface 104 obtains for an equipment part from system 402 may be structured in accordance with a particular hierarchy, such as that illustrated in FIG. 7A. In FIG. 7B, the hierarchy is reflected by the indentations of each line of text that represents a particular component. In FIG. 7B, when the user wishes to insert or view data on an existing subcomponent, the user may select a particular item under the component shown (e.g., “model” under “100G NETWORK CARD” (also referred to herein as “CI”) in FIG. 7B. When the user interface 750 receives the selection, using a model for equipment parts, such as model 700, user interface 750 may use the model to look up the list of subcomponent types, and display the list (not shown in FIG. 7B). In a different implementation, user interface 750 may forward the selection to system 402, which may then use the model to look up the list of subcomponent types and send the list to user interface 750 for display.

At interface 750, rather than viewing the list of subcomponents types for the component CI, the user may add a new subcomponent type (e.g., at “model”). When the user activates a menu item for creating a new template for the subcomponent type, window 752 pops open, allowing the user to enter the template name, comments, and/or other data.

FIG. 8 shows an exemplary JSON name-value pairs that define an exemplary model component according to one implementation. As explained above, after a user inputs data based on a template, template system 402 converts the equipment part data into JSON data—that is, JSON name-value pairs—using the template. For example, template system 402 generates JSON name-value pairs 802 in a text format, for the data input by the user, according to the requirements of the template. For FIG. 8, assume that the equipment part data which the user has input pertains to a template associated with a network card 800. Network card 800 includes slots 804-814 and ports 816. After the user inputs data for card 800 into the corresponding template, the data may be sent from user interface 104 to system 402. The data may then be converted into the JSON form shown by element 802. As shown, each slot 804-814 is described by corresponding JSON name-value pair. In FIG. 8, one name value pair for a slot is “name” and the corresponding name of the slot (e.g., “name” and value “1”). Similarly, a name value pair for a port is a physical port name and the corresponding name of the physical port (e.g., “physicalportname” and “1-TX”). FIG. 8 is merely an example—not all of the JSON name-value pairs that may be associated with the network card are illustrated in FIG. 8.

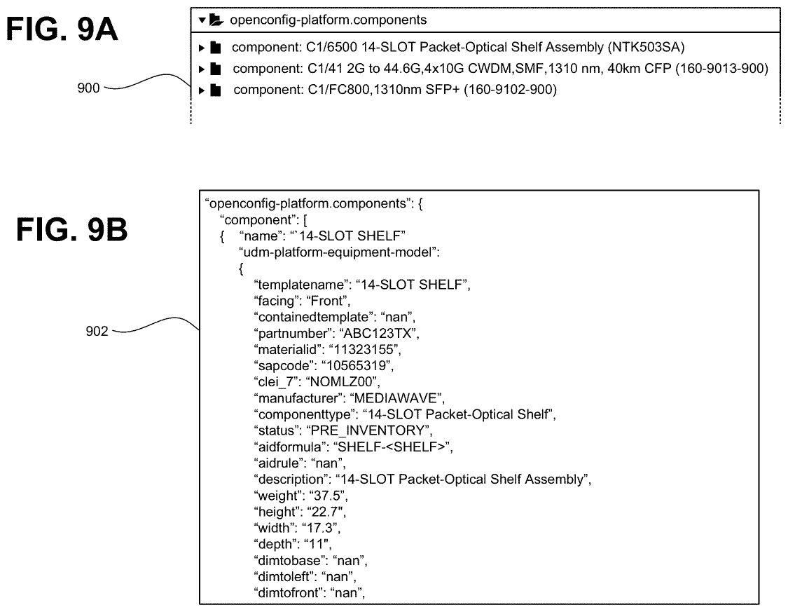

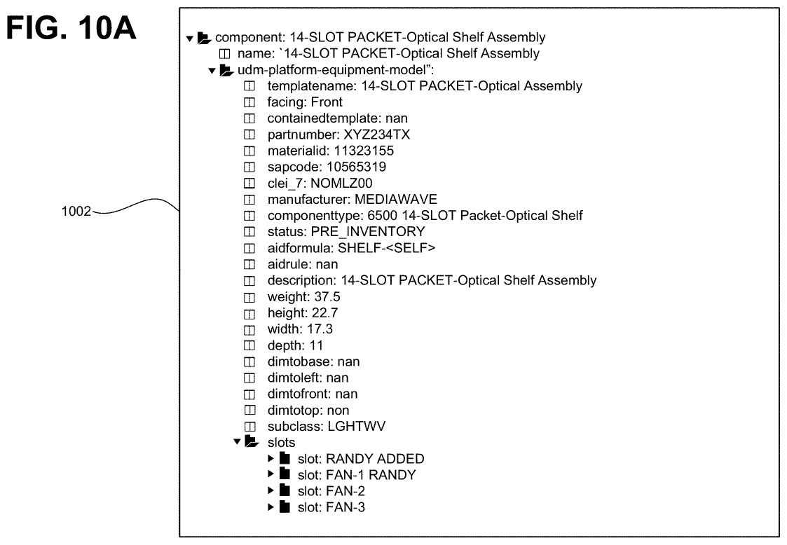

FIG. 9A shows a portion of an exemplary a user interface 900 that lists exemplary equipment parts whose descriptions are stored in the databases of FIG. 5. User interface 900 (or a user interface similar to user interface 900) may be shown to a network operator, a vendor, or another type of user that is viewing equipment part data, inputting the equipment part data, requesting the provisioning system to provision a network component, reviewing equipment part data, etc. As shown, user interface 900 lists three network equipment parts, each part per line.

FIG. 9B shows an exemplary corresponding JSON name-value pairs 902 for one of the equipment parts listed in the user interface 900 of FIG. 9A, according to one implementation. Depending on the implementation, the JSON name-value pairs may also be shown at user interface 104. The data corresponding to the name-value pairs may be stored at database 508, and in some implementations, also at transformer 502. Some of the name value pairs for one of the equipment parts of FIG. 9A includes: “name” and “14-SLOT Shelf”; “facing” (which indicates the orientation of the equipment part) and “Front”; “partnumber” for a part number and “ABC123TX”; “sapcode” for an assigned code and “10565319”; “manufacturer” and “MEDIAWAVE”; “componenttype” for a component type and “6500 14-SLOT Packet-Optical Shelf”; “status” for the status of the part (e.g., ACTIVATED, PRE-INVENTORY, etc.) and “PRE_INVENTORY”; “description” for the description of the component and “14-SLOT Packet-Optical Shelf Assembly”; “weight” for the weight and “37.5”; “height” and 37.5; “height” and 22.7; “width” and 17.3; “depth” and 11. JSON name-value pairs 902 also include spacing between the equipment part to its slot, such as a dimension to base (“dimtobase”), a dimension to left (“dimtoleft”); a dimension to front “dimtofront”).

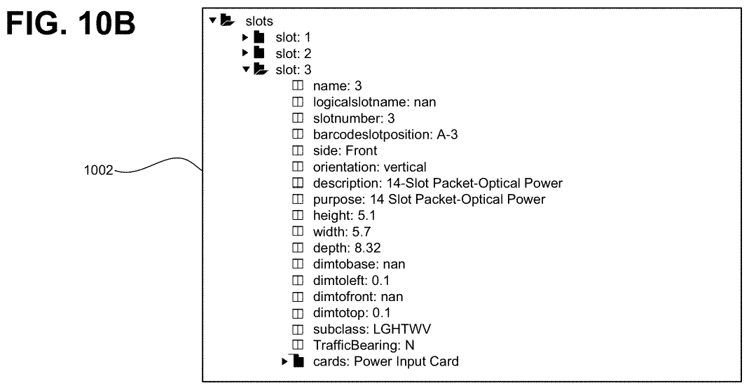

FIGS. 10A and 10B illustrate an exemplary user interface 1002 that displays a list of one or more network equipment parts information (also referred to as “properties”) pertaining to the equipment part. For each of the illustrated equipment parts and their properties in FIGS. 10A and 10B, there exists corresponding JSON name-value pairs in template system 402 (e.g., database 508 or at another database within transformer 502). In FIG. 10A, user interface 1002 shows an expanded view of one for the equipment parts of FIG. 9A. In particular, the expanded view shows many of the JSON name value pairs of FIG. 9B. In addition, interface 1002 shows that the JSON name-value pairs for “slots.” The slots' name-value pairs reflect the physical slots of the network card corresponding to the equipment part listed in user interface 1002. As shown, for the name “slots,” there are individual slots, as the value for the name. For each of the slots, its name is shown in FIG. 10A (e.g., RANDY-ADDED, FAN-1 RANDY, FAN-2, and FAN-3).

FIG. 10B illustrates a further portion of user interface 1002. As shown in FIG. 10B, each of the slots is associated with properties. Accordingly, there exists the corresponding JSON name-value pairs for each of the slots. In FIG. 10B, for slot 3, user interface 1002 shows its properties. Some of the shown properties include: “logicalslotname” for the logical slot name and NAN for its value; “slotnumber” for the slot number associated with the slot and the value 3; “barcodeslotposition” for the slot position as indicated by the bar code and the value “−3”; “side” for the location of the slot on the card and the value “Front”; “orientation” for the orientation of the slot and the value “vertical”; “description” for a description of the slot and the value “14-Slot Packet-Optical Power”; “purpose” for the purpose for the existence of the slot and the value “14 Slot Packet-Optical Power”; etc. The name value pairs also include its dimensions (height, width, and depth) and their values. The name “TrafficBearing” and the value of N indicate whether the slot is for traffic bearing. As shown at the bottom of user interface 1002, the slot 3 also includes a child card. Although the child card has properties, they are not shown in FIG. 10B.

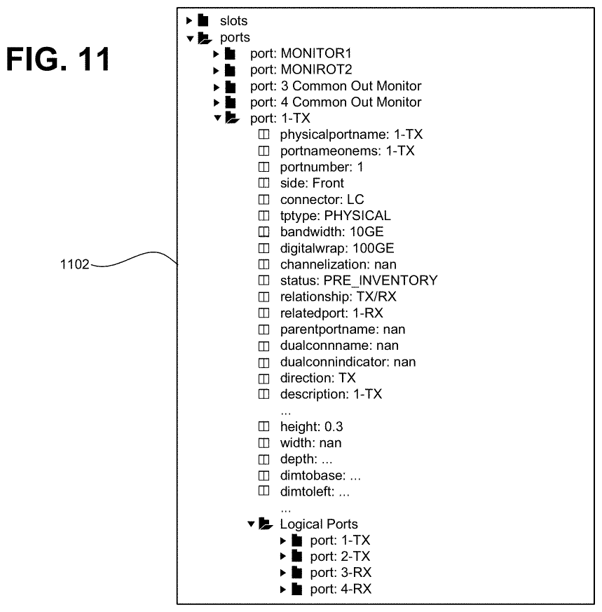

FIG. 11 shows an exemplary user interface 1102 that displays a list of ports and logical ports. Similar to slots, ports are part of a network card, and thus is listed in user interface 1102 as part of network card properties. In FIG. 11, for port “1-TX”, some of the name value pairs include: “physicalportname” for the name of the port and “1-TX” for the value; “portnameonems” for the name on ems and “1-TX” for the value; “portnumber” for the port number and “1” for the value: “side” for the location of the port and “Front” for the value; “connector” for the type of connector to be used for the port and “LC” for the value; “tptype” for the type of port and “PHYSICAL” for the value (a port may be a physical port or a logical port); “bandwidth” for the bandwidth associated with the port and “10GE” for the value; “status” for the status of the port and “PRE_INVENTORY” for the value; “relationship” of the port to its pair and “TX/RX” for the value; “relatedport” for the port related to the instant port and “1-RX” for the value (i.e., the name of the related port); “parentportname” for the name of the parent port and NAN for the value (i.e., no parent port exists); “direction” to indicate whether the port is for transmission or reception and “TX” for the value (i.e., for transmission); “description” for the description of the port and “1-TX” for the value. The JSON name-value pairs shown in user interface 1102 may also include the dimensions and their corresponding values, such as height, 0.3; width, NAN (no width); depth, etc. The JSON name-value pairs also include the port's position, such as “dimtobase,” “dimtoleft,” etc.

Each port may be a parent to a logical port. For example, user interface 1102 show multiple logical ports under port “1-TX”—the parent to the logical ports. The properties of each of the logical ports under port “1-TX”, although not illustrated in FIG. 11B, are similar to those for the physical ports, such as port “1-TX” (or other physical ports). Depending on the implementation, a physical port may not have any child logical ports.

In this specification, various preferred embodiments have been described with reference to the accompanying drawings. Modifications may be made thereto, and additional embodiments may be implemented, without departing from the broader scope of the invention as set forth in the claims that follow. The specification and drawings are accordingly to be regarded in an illustrative rather than restrictive sense.

While a series of processes have been described above regarding blocks illustrated in FIG. 6, the order of the processing may be modified in other implementations. In addition, non-dependent processing may be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store, or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A system comprising one or more devices configured to:
receive data input to a template for a network equipment part;
convert the data into JavaScript Object Notation (JSON) name-value pairs;
store the JSON name-value pairs in a database;
receive a request to provision a network component for an access network;
identify equipment parts that are to be used to assemble the network component;
assemble the network component using the equipment parts; and
deploy the network component in the access network.

2. The system of claim 1, wherein the one or more devices are further configured to:
receive user input to design the template; and
store the template in a second database.

3. The system of claim 2, wherein the one or more devices are configured to:
retrieve the template from the second database based on a user selection of the equipment part.

4. The system of claim 1, wherein when the one or more devices convert the data into the JSON name-value pairs, the one or more devices are configured to:
retrieve a script corresponding to the template; and
execute the script that converts the data into the JSON name-value pairs.

5. The system of claim 1, wherein when the one or more devices store the JSON name-value pairs, the one or more devices are further configured to:
assign a part identifier (ID) for the equipment part;
obtain a barcode corresponding to the equipment part; and
store the part ID and the barcode with the JSON name-value pairs.

6. The system of claim 1, wherein when the one or more devices deploy the network component, the one or more devices are further configured to:
integrate the network component into the access network, wherein integrating the network component into the access network changes topology of the access network;
activate the network component; and
store information that captures the changed topology of the access network.

7. The system of claim 1, wherein a network equipment part is described by a data model that includes a parent port model and a parent network card model, wherein the parent network card model is a property of a parent slot model.

8. The system of claim 7, wherein the parent port model includes at least one logical port model.

9. The system of claim 8, wherein the parent port model includes data corresponding to JSON name-value pairs, and wherein the JSON name-value pairs include names and values for at least one of:
a name of the port;
dimensions of the port; and
an indication of whether the port is a physical port or a logical port.

10. A method comprising:
receiving data input to a template for a network equipment part;
converting the data into JavaScript Object Notation (JSON) name-value pairs;
storing the JSON name-value pairs in a database;
receiving a request to provision a network component for an access network;
identifying equipment parts that are to be used to assemble the network component;
assembling the network component using the equipment parts; and
deploying the network component in the access network.

11. The method of claim 10, further comprising:
receiving user input to design the template; and
storing the template in a second database.

12. The method of claim 11, further comprising:
retrieving the template from the second database based on a user selection of the equipment part.

13. The method of claim 10, wherein converting the data into the JSON name-value pairs includes:
retrieving a script corresponding to the template; and
executing the script that converts the data into the JSON name-value pairs.

14. The method of claim 10, wherein storing the JSON name-value pairs includes:
assigning a part identifier (ID) for the equipment part;
obtaining a barcode corresponding to the equipment part; and
storing the part ID and the barcode with the JSON name-value pairs.

15. The method of claim 10, wherein deploying the network component includes:
Integrating the network component into the access network, wherein integrating the network component into the access network changes topology of the access network;
activating the network component; and
storing information that captures the changed topology of the access network.

16. The method of claim 10, wherein a network equipment part is described by a data model that includes a parent port model and a parent network card model, wherein the parent network card model is a property of a parent slot model.

17. The method of claim 16, wherein the parent port model includes at least one logical port model.

18. The method of claim 17, wherein the parent port model includes data corresponding to JSON name-value pairs, and wherein the JSON name-value pairs include names and values for at least one of:
a name of the port;
dimensions of the port; and
an indication of whether the port is a physical port or a logical port.

19. A non-transitory computer-readable medium comprising processor-executable instructions, what when executed by one or more processors, cause the one or more processors to:
receive data input to a template for a network equipment part;
convert the data into JavaScript Object Notation (JSON) name-value pairs;
store the JSON name-value pairs in a database;
receive a request to provision a network component for an access network;
identify equipment parts that are to be used to assemble the network component;
assemble the network component using the equipment parts; and
deploy the network component in the access network.

20. The non-transitory computer-readable medium of claim 19, wherein the one or more processors further execute the instructions to:
receive user input to design the template; and
store the template in a second database.
